(19) United States
(12) Patent Application Publication
(10) Pub. No.: US 2018/0025225 A1
(43) Pub. Date: Jan. 25, 2018

(54) SYSTEM AND METHOD FOR GENERATING CONSOLIDATED DATA FOR ELECTRONIC DOCUMENTS

(71) Applicant: Vatbox, Ltd., Herzeliya (IL)

(72) Inventors: Noam GUZMAN, Ramat Hasharon (IL); Isaac SAFT, Kfar Neter (IL)

(73) Assignee: Vatbox, Ltd., Herzeliya (IL)

(21) Appl. No.: 15/669,510

(22) Filed: Aug. 4, 2017

Related U.S. Application Data
(63) Continuation-in-part of application No. 15/361,934, filed on Nov. 28, 2016.
(60) Provisional application No. 62/371,221, filed on Aug. 5, 2016.
(60) Provisional application No. 62/260,553, filed on Nov. 29, 2015.
(60) Provisional application No. 62/261,355, filed on Dec. 1, 2015.

(51) Int. Cl. G06K 9/00; G06F 17/24; G06Q 40/00; G06F 17/30

(52) U.S. Cl. CPC G06K 9/00469; G06K 9/00483; G06F 17/30011; G06F 17/248; G06Q 40/123; G06K 2209/01

(57) ABSTRACT

A system and method generating consolidated data based on electronic documents. The method includes analyzing a first electronic document to determine at least one transaction parameter, the first electronic document indicating a transaction including at least one expense, wherein the first electronic document includes at least partially unstructured data; creating a template for the first electronic document, wherein the template is a structured dataset including the determined at least one transaction parameter; retrieving, based on the template, a second electronic document, wherein the second electronic document indicates evidence of the transaction; determining at least one deductible expense of the at least one expense based on at least one deduction rule, the template, and the second electronic document; and generating consolidation metadata based on the determined at least one deductible expense.

### CROSS-REFERENCE TO RELATED APPLICATIONS

This application claims the benefit of U.S. Provisional Application No. 62/371,221 filed on Aug. 5, 2016. This application is also a continuation-in-part of U.S. patent application Ser. No. 15/361,934 filed on Nov. 28, 2016, now pending, which claims the benefit of U.S. Provisional Application No. 62/260,553 filed on Nov. 29, 2015, and of U.S. Provisional Application No. 62/261,355 filed on Dec. 1, 2015. The contents of the above-referenced applications are hereby incorporated by reference.

### TECHNICAL FIELD

The present disclosure relates generally to verifying files in data systems, and more particularly to verifying requests based on contents of electronic documents.

### BACKGROUND

Customers can place orders for services such as travel and accommodations from merchants in real-time over the web. These orders can be received and processed immediately. However, payments for the orders typically require more time to complete and, in particular, to secure the money being transferred. Therefore, merchants typically require the customer to provide assurances of payment in real-time while the order is being placed. As an example, a customer may input credit card information pursuant to a payment, and the merchant may verify the credit card information in real-time before authorizing the sale. The verification typically includes determining whether the provided information is valid (i.e., that a credit card number, expiration date, PIN code, and/or customer name match known information).

Upon receiving such assurances, a purchase order may be generated for the customer. The purchase order provides evidence of the order such as, for example, a purchase price, goods and/or services ordered, and the like. Later, an invoice for the order may be generated. While the purchase order is usually used to indicate which products are requested and an estimate or offering for the price, the invoice is usually used to indicate which products were actually provided and the final price for the products. Frequently, the purchase price as demonstrated by the invoice for the order is different from the purchase price as demonstrated by the purchase order. As an example, if a guest at a hotel initially orders a 3-night stay but ends up staying a fourth night, the total price of the purchase order may reflect a different total price than that of the subsequent invoice. Cases in which the total price of the invoice is different from the total price of the purchase order are difficult to track, especially in large enterprises accepting many orders daily (e.g., in a large hotel chain managing hundreds or thousands of hotels in a given country). The differences may cause errors in recordkeeping for enterprises.

As businesses increasingly rely on technology to manage data related to operations such as invoice and purchase order data, suitable systems for properly managing and validating data have become crucial to success. Particularly for large businesses, the amount of data utilized daily by businesses can be overwhelming. Accordingly, manual review and validation of such data is impractical, at best. However, disparities between recordkeeping documents can cause significant problems for businesses such as, for example, failure to properly report earnings to tax authorities.

Some solutions exist for automatically recognizing information in scanned documents (e.g., invoices and receipts) or other unstructured electronic documents (e.g., unstructured text files). Such solutions often face challenges in accurately identifying and recognizing characters and other features of electronic documents. Moreover, degradation in content of the input unstructured electronic documents typically result in higher error rates. As a result, existing image recognition techniques are not completely accurate under ideal circumstances (i.e., very clear images), and their accuracy often decreases dramatically when input images are less clear. Moreover, missing or otherwise incomplete data can result in errors during subsequent use of the data. Many existing solutions cannot identify missing data unless, e.g., a field in a structured dataset is left incomplete.

In addition, existing image recognition solutions may be unable to accurately identify some or all special characters (e.g., “!,” “@,” “#,” “$,” “©,” “%,” “&,” etc.). As an example, some existing image recognition solutions may inaccurately identify a dash included in a scanned receipt as the number “1.” As another example, some existing image recognition solutions cannot identify special characters such as the dollar sign, the yen symbol, etc.

Further, such solutions may face challenges in preparing recognized information for subsequent use. Specifically, many such solutions either produce output in an unstructured format, or can only produce structured output if the input electronic documents are specifically formatted for recognition by an image recognition system. The resulting unstructured output typically cannot be processed efficiently. In particular, such unstructured output may contain duplicates, and may include data that requires subsequent processing prior to use.

Business expenses are expenses made as the cost of carrying on a trade or business. These expenses are often deductible. Deductible expenses are expenses that are subtracted from a company's income before it is subject to taxation. Standard business deductions may include, for example, general and administrative expenses, business-related travel and entertainment expenses, automobile expenses, and employee benefits. Some business expenses are “current” and must be deducted in the year that they are paid, while others are “capitalized” and, therefore, are spread out or depreciated over time.

There are some business expenses that are prohibited by law from deducting, such as bribes, traffic tickets, clothing that is not a uniform, and unreasonably large expenses (such as a large jet for a small local business). The rules and laws for expense deductions vary by jurisdiction, and therefore may be challenging to apply correctly. In particular, large multi-national corporations may face challenges in identifying which expenses are deductible. This problem is further compounded when expense reports and evidencing documents (e.g., receipts and invoices) include unstructured data, which may result in inefficient or inaccurate processing. The challenges in identifying deductible expenses is a serious issue, as improper submissions may carry legal penalties and withholding submissions for fear of such penalties may result in loss of money.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments disclosed herein include a method for generating consolidated data based on electronic documents. The method comprises: analyzing a first electronic document to determine at least one transaction parameter, the first electronic document indicating a transaction including at least one expense, wherein the first electronic document includes at least partially unstructured data; creating a template for the first electronic document, wherein the template is a structured dataset including the determined at least one transaction parameter; retrieving, based on the template, a second electronic document, wherein the second electronic document indicates evidence of the transaction; determining at least one deductible expense of the at least one expense based on at least one deduction rule, the template, and the second electronic document; and generating consolidation metadata based on the determined at least one deductible expense.

Certain embodiments disclosed herein also include a non-transitory computer readable medium having stored thereon instructions for causing a processing circuitry to perform a process generating consolidated data based on electronic documents, the process comprising: analyzing a first electronic document to determine at least one transaction parameter, the first electronic document indicating a transaction including at least one expense, wherein the first electronic document includes at least partially unstructured data; creating a template for the first electronic document, wherein the template is a structured dataset including the determined at least one transaction parameter; retrieving, based on the template, a second electronic document, wherein the second electronic document indicates evidence of the transaction; determining at least one deductible expense of the at least one expense based on at least one deduction rule, the template, and the second electronic document; and generating consolidation metadata based on the determined at least one deductible expense.

Certain embodiments disclosed herein also include a system generating consolidated data based on electronic documents. The system comprises: a processing circuitry; and a memory, the memory containing instructions that, when executed by the processing circuitry, configure the system to: analyze a first electronic document to determine at least one transaction parameter, the first electronic document indicating a transaction including at least one expense, wherein the first electronic document includes at least partially unstructured data; create a template for the first electronic document, wherein the template is a structured dataset including the determined at least one transaction parameter; retrieve, based on the template, a second electronic document, wherein the second electronic document indicates evidence of the transaction; determine at least one deductible expense of the at least one expense based on at least one deduction rule, the template, and the second electronic document; and generate consolidation metadata based on the determined at least one deductible expense.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of a validation system according to an embodiment.

FIG. 3 is a flowchart illustrating a method for consolidating electronic documents according to an embodiment.

FIG. 4 is a flowchart illustrating a method for creating a dataset based on at least one electronic document according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for consolidating electronic documents. In an embodiment, a dataset is created based on a first expense report electronic document indicating information related to a transaction. A template of transaction attributes is created based on the first electronic document dataset.

Based on the created template, a second evidencing electronic document providing evidence of the transaction may be retrieved. The expense report electronic document and the evidencing electronic document may be compared to determine whether there is a difference in values of one or more transaction parameters indicated therein. When there is a difference, a cause of the difference may be determined. Based on the expense report template, data of the evidencing electronic document, and one or more characteristics of an enterprise, deduction rules are retrieved. Based on the rules, the expense report template, and the data of the evidencing electronic document, one or more deductible expenses may be determined. Metadata indicating the determined deductible expenses is generated and sent to, an enterprise system.

In some implementations, based on metadata of deductible expenses for multiple expense report electronic documents, for example expense report documents associated with different enterprises (e.g., different subsidiary businesses owned by the same parent company), a consolidated expense report electronic document may be generated. The consolidated expense report electronic document indicates expenses for the different enterprises. Thus, the metadata of the deductible expenses may be utilized as consolidation data for reporting consolidated expenses.

The disclosed embodiments allow for automatic consolidation of electronic documents with respect to deductible expenses indicated therein. More specifically, the disclosed embodiments include providing structured dataset templates for electronic documents, thereby allowing for retrieving evidencing documents based on electronic expense reports that are unstructured, semi-structured, or otherwise lacking a known structure. For example, the disclosed embodiments may be used to effectively analyze images of scanned expense reports for transactions, thereby allowing for more accurate recognition of portions of the expense reports requiring evidence and, consequently, of appropriate documentation evidencing the transactions. The determined deductible expenses may be utilized to create consolidated expense reports indicating valid expenses.

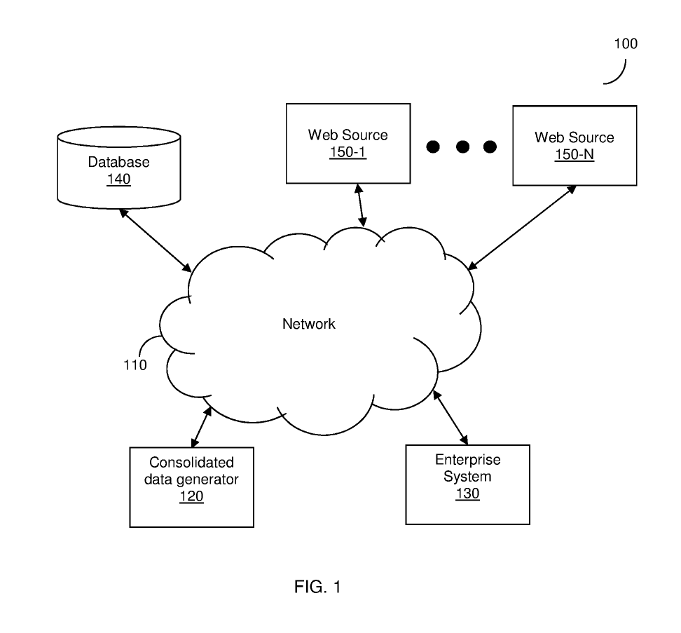

FIG. 1 shows an example network diagram 100 utilized to describe the various disclosed embodiments. In the example network diagram 100, a consolidated data generator 120, an enterprise system 130, a database 140, and a plurality of web sources 150-1 through 150-N (hereinafter referred to individually as a web source 150 and collectively as web sources 150, merely for simplicity purposes), are communicatively connected via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The enterprise system 130 is associated with an enterprise, and may store data related to purchases made by the enterprise or representatives of the enterprise as well as enterprise characteristic parameters indicating characteristics of the enterprise such as, but not limited to, country of formation, revenue data, structural data, and the like. The enterprise may be, but is not limited to, a business whose employees may purchase goods and services subject to VAT taxes while abroad. The enterprise system 130 may be, but is not limited to, a server, a database, an enterprise resource planning system, a customer relationship management system, or any other system storing relevant data.

The purchase-related data may include, for example, electronic documents. Each electronic document stored by the enterprise system 130 may show, e.g., an expense report, or an evidence of a transaction (e.g., a receipt, an invoice, a purchase confirmation, and the like). Data included in each electronic document may be structured, semi-structured, unstructured, or a combination thereof. The structured or semi-structured data may be in a format that is not recognized by the consolidated data generator 120 and, therefore, may be treated as unstructured data.

The database 140 may store metadata generated by the consolidated data generator 120 to be utilized for generating consolidated expense report electronic documents. The web sources 150 may store evidencing electronic documents, deduction rules, or both. The evidencing electronic documents may be utilized as evidence for granting requests such as, for example, invoices, tax receipts, order confirmations, and the like. The deduction rules may define expenses that may be deducted (e.g., based on types, amounts, etc.), and may further define such deductible expenses with respect to characteristics of the enterprise such as, but not limited to, country of incorporation, revenue data, structural data (e.g., subsidies), and the like.

The web sources 150 may include, but are not limited to, servers or devices of merchants, tax authority servers, accounting servers, a database associated with an enterprise, and the like. As a non-limiting example, the web source 150-1 may be a merchant server storing image files showing invoices for transactions made by a merchant associated with the merchant server, and the web source 150-2 may be a tax authority server storing deduction rules for expenses incurred in a particular country.

In an embodiment, the consolidated data generator 120 is configured to create a template based on transaction parameters identified using machine vision of a first expense report electronic document indicating information related to a transaction including one or more expenses. In a further embodiment, the consolidated data generator 120 may be configured to retrieve the expense report electronic document from, e.g., the enterprise system 130. Based on the created template, the consolidated data generator 120 is configured to retrieve, from one of the web sources 150, a second evidencing electronic document indicating information evidencing the transaction.

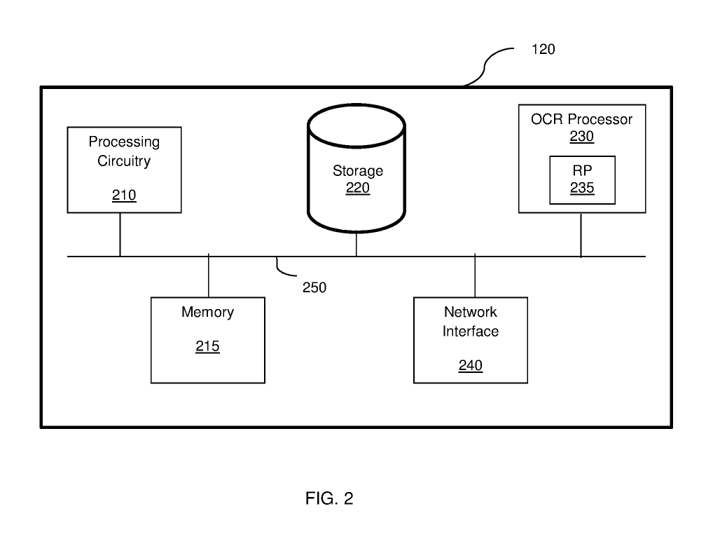

In an embodiment, the consolidated data generator 120 is configured to create datasets based on electronic documents including data at least partially lacking a known structure (e.g., unstructured data, semi-structured data, or structured data having an unknown structure). To this end, the consolidated data generator 120 may be further configured to utilize optical character recognition (OCR) or other image processing to determine data in the electronic document. The consolidated data generator may therefore include or be communicatively connected to a recognition processor (e.g., the recognition processor 235, FIG. 2).

In an embodiment, the consolidated data generator 120 is configured to analyze the created dataset for the expense report electronic document to identify transaction parameters related to transactions indicated in the expense report electronic document. The transaction parameters indicate information of one or more expenses. The consolidated data generator 120 is configured to create a template based on the dataset. Each template is a structured dataset including the identified transaction parameters for a transaction.

In an embodiment, based on the expense report template, the consolidated data generator 120 is configured to retrieve a second evidencing electronic document. The retrieved evidencing electronic document matches the expense report electronic document, for example, with respect to a set of uniquely identifying transaction parameters in each of the evidencing electronic document and the expense report electronic document. For example, the retrieved evidencing electronic document may have the same transaction identifier number, or may have the same date and merchant identifier. If no matching second evidencing electronic document can be retrieved, the consolidated data generator 120 may be configured to determine that no expenses indicated in the expense report electronic document are deductible.

Using structured templates for determining whether expenses are deductible allows for more efficient and accurate determination than, for example, by utilizing unstructured data. Specifically, corresponding deduction rules may be analyzed only with respect to relevant portions of an expense report electronic document (e.g., portions included in specific fields of a structured template), thereby reducing the number of instances of application of each rule as well as reducing false positives due to applying rules to data that is likely unrelated to each rule. Further, the uniquely identifying transaction parameters utilized to retrieve the corresponding evidencing electronic document may be extracted from specific fields of the created template rather than requiring comparison to all unstructured data of the expense report electronic document.

In an embodiment, based on comparison between the template and the retrieved evidencing electronic document, the consolidated data generator 120 is configured to determine whether there is a difference in values of one or more transaction parameters in the compared electronic documents. To this end, the comparison may include comparing transaction parameters in the created template to transaction parameters indicated in the evidencing electronic document. The transaction parameters compared to determine the difference may be parameters related to expenses, and more specifically may be parameters requiring evidence in order to be successfully deducted. For example, the compared transaction parameters may include a price per expense (e.g., good or service purchased). The difference may be, for example, a numerical difference (e.g., a difference in price, quantity, or both), a proportion, and the like.

In some implementations, comparing the electronic documents may further creating an evidencing template for the evidencing electronic document and comparing the evidencing template to the expense report template with respect to corresponding fields of the transaction parameters to be compared. For example, data indicated in a “price” field of each template may be compared. Comparing data of structured templates may further allow for more accurate and efficient determination of differences.

In an embodiment, when a difference is determined, the consolidated data generator 120 may be further configured to determine a cause of the difference. The cause of the difference may be determined based on one or more causation rules with respect to the determined difference and the compared transaction parameters. The causation rules may be related to, for example, differences due to additional or refunded purchases, differences in currency exchange rates, taxes (e.g., VATs) that were not charged at a time of purchase, incidental charges, gratuity charges, and other potential reasons that may be indicated by the values of the transaction parameters.

As an example, a difference of +$100.51 may be associated with an additional night's stay at a hotel and a difference of −$100.51 may be associated with a refund for a night's stay when the type of room has a cost of $100.51 per night.

Based on the cause of the difference, it may be determined if the expense is deductible. To this end, certain predetermined causes may be associated with non-deductible expenses. For example, a cause of difference indicating that a refund of 1 night's hotel stay may result in determining that the full expense (i.e., the expense including the refunded night) is not to be deducted. In further implementations, it may be determined whether the expense is partially deductible based on the cause of the difference. For example, if the cause of the difference is a partial refund (e.g., a refund of one night's hotel stay out of 3 total nights), the non-refunded portion of the expense may be determined as the expense to be deducted.

In an embodiment, based on the enterprise characteristic parameters of the enterprise, the expense report electronic document, the evidencing electronic document, or a combination thereof, the consolidated data generator 120 is configured to retrieve deduction rules from one or more of the web sources 150. For example, the retrieved deduction rules may be retrieved based on the country of formation of the business (e.g., from a web source 150 of a tax authority associated with the country of formation), the structure of the enterprise, the most recent annual revenue for the enterprise, combinations thereof, and the like.

In an embodiment, the consolidated data generator 120 is configured to apply the retrieved rules to data of the expense report template, the evidencing electronic document, the enterprise characteristics, or a combination thereof, in order to determine whether each expense indicated in the expense report electronic document is deductible. Further, a deductible amount may be determined for each expense. The deductible amount may be determined, for example, as a proportion of the total amount of the expense or a partial amount of the expense (for example, if the expense is determined to be partially deductible as described herein above).

In an embodiment, the consolidated data generator 120 is configured to generate metadata based on the determined deductible expense. The metadata may include, for example, a deductible amount, an indication of which expenses of the transaction are deductible, the cause of a difference between the expense report and the evidencing document, a combination thereof, and the like. The consolidated data generator 120 may be further configured to generate a notification including the metadata.

The generated metadata may be utilized as consolidated data for creating a consolidated expense report. To this end, in some implementations, the consolidated data generator 120 may be configured to generate a consolidated expense report electronic document based on a plurality of sets of metadata. The sets of metadata may be related to different expense reports, and may be further related to expense reports from different enterprises. Thus, the consolidated expense report electronic document may be utilized for consolidating expenses for, e.g., tax reporting purposes.

It should be noted that the embodiments described herein above with respect to FIG. 1 are described with respect to one enterprise system 130 merely for simplicity purposes and without limitation on the disclosed embodiments. Multiple enterprise systems may be equally utilized without departing from the scope of the disclosure.

FIG. 2 is an example schematic diagram of the consolidated data generator 120 according to an embodiment. The consolidated data generator 120 includes a processing circuitry 210 coupled to a memory 215, a storage 220, and a network interface 240. In an embodiment, the consolidated data generator 120 may include an optical character recognition (OCR) processor 230. In another embodiment, the components of the consolidated data generator 120 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 215 may be volatile (e.g., RAM, etc.), non-volatile (e.g., ROM, flash memory, etc.), or a combination thereof. In one configuration, computer readable instructions to implement one or more embodiments disclosed herein may be stored in the storage 220.

In another embodiment, the memory 215 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 210 to perform the various processes described herein. Specifically, the instructions, when executed, cause the processing circuitry 210 to generate consolidated data based on electronic documents, as discussed herein.

The storage 220 may be magnetic storage, optical storage, and the like, and may be realized, for example, as flash memory or other memory technology, CD-ROM, Digital Versatile Disks (DVDs), or any other medium which can be used to store the desired information.

The OCR processor 230 may include, but is not limited to, a feature and/or pattern recognition processor (RP) 235 configured to identify patterns, features, or both, in unstructured data sets. Specifically, in an embodiment, the OCR processor 230 is configured to identify at least characters in the unstructured data. The identified characters may be utilized to create a dataset including data required for verification of a request.

The network interface 240 allows the consolidated data generator 120 to communicate with the enterprise system 130, the database 140, the web sources 150, or a combination of, for the purpose of, for example, collecting metadata, retrieving data, storing data, and the like.

It should be understood that the embodiments described herein are not limited to the specific architecture illustrated in FIG. 2, and other architectures may be equally used without departing from the scope of the disclosed embodiments.

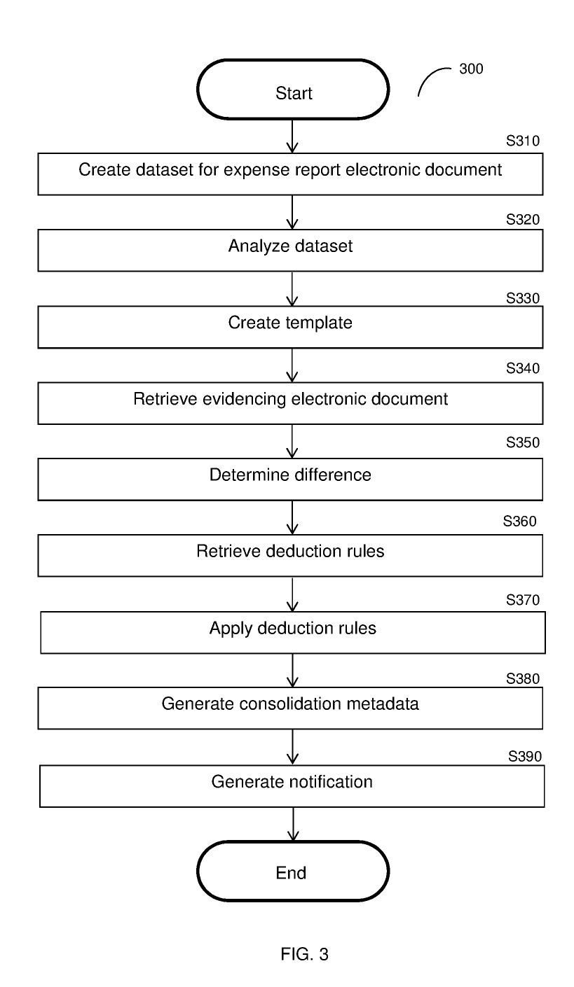

FIG. 3 is an example flowchart 300 illustrating a method for generating consolidated data based on electronic documents according to an embodiment. In an embodiment, the method may be performed by a consolidated data generator (e.g., the consolidated data generator 120).

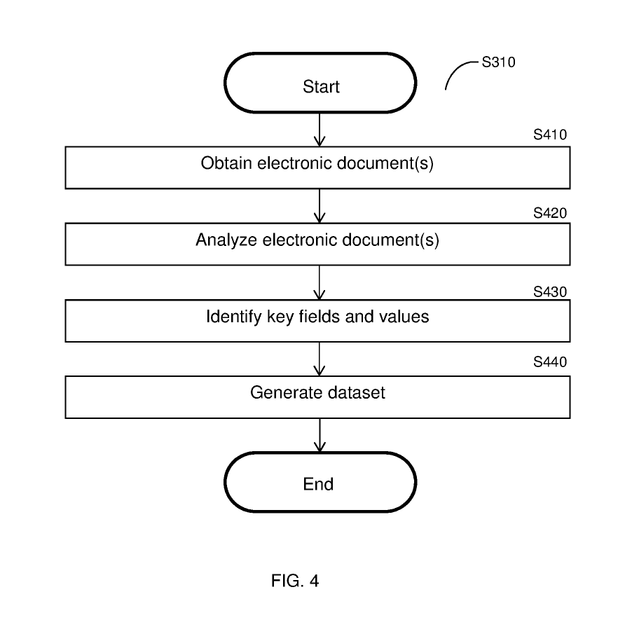

At S310, a dataset is created based on a first expense report electronic document including information related to a transaction. The transaction includes one or more expenses. The expense report electronic document may include, but is not limited to, unstructured data, semi-structured data, structured data with structure that is unanticipated or unannounced, or a combination thereof. In an embodiment, S310 may further include analyzing the expense report electronic document using optical character recognition (OCR) to determine data in the electronic document, identifying key fields in the data, identifying values in the data, or a combination thereof. Creating datasets based on electronic documents is described further herein below with respect to FIG. 4.

At S320, the expense report dataset is analyzed. In an embodiment, analyzing the expense report dataset may include, but is not limited to, determining transaction parameters such as, but not limited to, at least one entity identifier (e.g., a consumer enterprise identifier, a merchant enterprise identifier, or both), information related to the transaction (e.g., a date, a time, a price, a type of good or service sold, etc.), or both. In a further embodiment, analyzing the expense report dataset may also include identifying the expenses of the transaction based on the expense report dataset.

At S330, a template is created based on the expense report dataset. The template may be, but is not limited to, a data structure including a plurality of fields. The fields may include the identified transaction parameters. The fields may be predefined.

Creating templates from electronic documents allows for faster processing due to the structured nature of the created templates. For example, query and manipulation operations may be performed more efficiently on structured datasets than on datasets lacking such structure. Further, organizing information from electronic documents into structured datasets, the amount of storage required for saving information contained in electronic documents may be significantly reduced. Electronic documents are often images that require more storage space than datasets containing the same information. For example, datasets representing data from 100,000 image electronic documents can be saved as data records in a text file. A size of such a text file would be significantly less than the size of the 100,000 images.

At S340, based on the created template, a second evidencing electronic document is retrieved. The retrieved evidencing electronic document indicates evidence of the transaction of the expense report electronic document. In an embodiment, S340 includes searching, based on a set of uniquely identifying transaction parameters in the template, in at least one web source. As a non-limiting example, a transaction identification number “123456789” indicated in a “Transaction ID” field of the first template may be utilized as a search query to find the second electronic document based on, e.g., metadata of the second electronic document including the transaction identification number “123456789.” In a further embodiment, S340 includes selecting the at least one web source based on the first template. In some implementations, if an evidencing electronic document is not retrieved (i.e., if no evidencing electronic document matches the expense report electronic document), the expenses indicated in the expense report electronic document may be determined to be non-deductible and execution terminates.

At optional S350, based on the template and the retrieved evidencing electronic document, it may be determined whether there is a difference in one or more transaction parameters. In an embodiment, S350 includes comparing transaction parameters in the created template to corresponding data of the evidencing electronic document. In a further embodiment, S350 may also include creating a template for the evidencing electronic document and comparing data in one or more fields of the expense report electronic document to data in corresponding fields of the evidencing electronic document. In some implementations, if there is a difference in one or more sets of compared transaction parameters, each expense associated with the different compared transaction parameters may be determined to be non-deductible.

ln some embodiments, S350 may further include determining a cause of the difference. Based on the determined cause of the difference, it may be determined whether one or more of the expenses indicated in the expense report electronic document is non-deductible or only partially deductible. In some implementations, when the difference is a difference in amount (e.g., a different price for one of the expenses indicated in the expense report and in the invoice for the transaction), the higher value of the amount may be determined as non-deductible.

At S360, one or more deduction rules are retrieved from web sources. The deduction rules may be retrieved based on enterprise characteristics related to an enterprise (e.g., an enterprise associated with the expense report electronic document), and may be further retrieved based on the transaction parameters for the transaction. Specifically, the deduction rules may vary based on the country of formation of the enterprise, the structure of the enterprise (e.g., with respect to subsidiary and parent companies), the revenues of the enterprise, and the like.

At S370, the retrieved deduction rules are applied to the transaction parameters indicated in the expense report electronic document, the evidencing electronic document, or both. In some implementations, the deduction rules may not be applied with respect to transaction parameters of expenses that were determined to be non-deductible. The results of applying the deduction rules may include, but is not limited to, a determination of each deductible expense, a deduction amount for each deductible expense, or both.

At S380, metadata including the determined deductible expenses, deduction amounts, or both, is generated. The metadata may be utilized with metadata of other expense reports to generate a consolidated expense report, thereby consolidating expense reports.

At optional S390, a notification may be generated. The notification may include the metadata, an indication of the deductible expenses, the determined cause of the difference, or a combination thereof. In another embodiment, when one or more expenses are determined to be non-deductible, the notification may indicate the non-deductible expenses.

FIG. 4 is an example flowchart S310 illustrating a method for creating a dataset based on an electronic document according to an embodiment.

At S410, the electronic document is obtained. Obtaining the electronic document may include, but is not limited to, receiving the electronic document (e.g., receiving a scanned image) or retrieving the electronic document (e.g., retrieving the electronic document from a consumer enterprise system, a merchant enterprise system, or a database).

At S420, the electronic document is analyzed. The analysis may include, but is not limited to, using optical character recognition (OCR) to determine characters in the electronic document.

At S430, based on the analysis, key fields and values in the electronic document are identified. The key field may include, but are not limited to, merchant's name and address, date, currency, good or service sold, a transaction identifier, an invoice number, and so on. An electronic document may include unnecessary details that would not be considered to be key values. As an example, a logo of the merchant may not be required and, thus, is not a key value. In an embodiment, a list of key fields may be predefined, and pieces of data that may match the key fields are extracted. Then, a cleaning process is performed to ensure that the information is accurately presented. For example, if the OCR would result in a data presented as “1211212005”, the cleaning process will convert this data to 12/12/2005. As another example, if a name is presented as “Mo$den”, this will change to “Mosden”. The cleaning process may be performed using external information resources, such as dictionaries, calendars, and the like.

In a further embodiment, it is checked if the extracted pieces of data are completed. For example, if the merchant name can be identified but its address is missing, then the key field for the merchant address is incomplete. An attempt to complete the missing key field values is performed. This attempt may include querying external systems and databases, correlation with previously analyzed invoices, or a combination thereof. Examples for external systems and databases may include business directories, Universal Product Code (UPC) databases, parcel delivery and tracking systems, and so on. In an embodiment, S430 results in a complete set of the predefined key fields and their respective values.

At S440, a structured dataset is generated. The generated dataset includes the identified key fields and values.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for generating consolidated data based on electronic documents, comprising:
analyzing a first electronic document to determine at least one transaction parameter, the first electronic document indicating a transaction including at least one expense, wherein the first electronic document includes at least partially unstructured data;
creating a template for the first electronic document, wherein the template is a structured dataset including the determined at least one transaction parameter;
retrieving, based on the template, a second electronic document, wherein the second electronic document indicates evidence of the transaction;
determining at least one deductible expense of the at least one expense based on at least one deduction rule, the template, and the second electronic document; and
generating consolidation metadata based on the determined at least one deductible expense.

2. The method of claim 1, wherein determining the at least one transaction parameter further comprises:
identifying, in the first electronic document, at least one key field and at least one value;
creating, based on the first electronic document, a dataset, wherein the created dataset includes the at least one key field and the at least one value; and
analyzing the created dataset, wherein the at least one transaction parameter is determined based on the analysis.

3. The method of claim 2, wherein identifying the at least one key field and the at least one value further comprises:
analyzing the first electronic document to determine data in the first electronic document; and
extracting, based on a predetermined list of key fields, at least a portion of the determined data, wherein the at least a portion of the determined data matches at least one key field of the predetermined list of key fields.

4. The method of claim 3, wherein analyzing the first electronic document further comprises:
performing optical character recognition on the first electronic document.

5. The method of claim 1, further comprising:
determining, based on the second electronic document and the template created for the first electronic document, whether there is a difference between the first electronic document and the second electronic document with respect to at least one of the at least one expense; and
determining, for each determined difference, whether the respective expense is non-deductible.

6. The method of claim 5, wherein the second electronic document includes at least partially unstructured data, further comprising:
creating a structured dataset template for the second electronic document; and
comparing data in at least one field of the first electronic document template to data in at least one corresponding field of the second electronic document template, wherein the difference is determined based on the comparison.

7. The method of claim 5, further comprising:
for each of the at least one expense, when it is determined that there is a difference with respect to the expense, determining a cause of the difference, wherein whether each expense is non-deductible is determined based on the cause of the difference with respect to the expense.

8. The method of claim 1, wherein the first electronic document is associated with an enterprise, further comprising:
retrieving the at least one deduction rule based on at least one enterprise characteristic of the enterprise.

9. The method of claim 8, wherein the at least one enterprise characteristic includes at least one of: a country of formation, an enterprise structure, and a revenue.

10. A non-transitory computer readable medium having stored thereon instructions for causing a processing circuitry to perform a process, the process comprising:
analyzing a first electronic document to determine at least one transaction parameter, the first electronic document indicating a transaction including at least one expense, wherein the first electronic document includes at least partially unstructured data;
creating a template for the first electronic document, wherein the template is a structured dataset including the determined at least one transaction parameter;
retrieving, based on the template, a second electronic document, wherein the second electronic document indicates evidence of the transaction;
determining at least one deductible expense of the at least one expense based on at least one deduction rule, the template, and the second electronic document; and
generating consolidation metadata based on the determined at least one deductible expense.

11. A system for generating consolidated data based on electronic documents, comprising:
a processing circuitry; and
a memory, the memory containing instructions that, when executed by the processing circuitry, configure the system to:
analyze a first electronic document to determine at least one transaction parameter, the first electronic document indicating a transaction including at least one expense, wherein the first electronic document includes at least partially unstructured data;
create a template for the first electronic document, wherein the template is a structured dataset including the determined at least one transaction parameter;
retrieve, based on the template, a second electronic document, wherein the second electronic document indicates evidence of the transaction;
determine at least one deductible expense of the at least one expense based on at least one deduction rule, the template, and the second electronic document; and
generate consolidation metadata based on the determined at least one deductible expense.

12. The system of claim 11, wherein the system is further configured to:
identify, in the first electronic document, at least one key field and at least one value;
create, based on the first electronic document, a dataset, wherein the created dataset includes the at least one key field and the at least one value; and
analyze the created dataset, wherein the at least one transaction parameter is determined based on the analysis.

13. The system of claim 12, wherein the system is further configured to:
analyze the first electronic document to determine data in the first electronic document; and
extract, based on a predetermined list of key fields, at least a portion of the determined data, wherein the at least a portion of the determined data matches at least one key field of the predetermined list of key fields.

14. The system of claim 13, wherein the system is further configured to:
perform optical character recognition on the first electronic document.

15. The system of claim 11, wherein the system is further configured to:
determine, based on the second electronic document and the template created for the first electronic document, whether there is a difference between the first electronic document and the second electronic document with respect to at least one of the at least one expense; and
determine, for each determined difference, whether the respective expense is non-deductible.

16. The system of claim 15, wherein the system is further configured to:
create a structured dataset template for the second electronic document; and
compare data in at least one field of the first electronic document template to data in at least one corresponding field of the second electronic document template, wherein the difference is determined based on the comparison.

17. The system of claim 15, wherein the system is further configured to:
for each of the at least one expense, when it is determined that there is a difference with respect to the expense, determine a cause of the difference, wherein whether each expense is non-deductible is determined based on the cause of the difference with respect to the expense.

18. The system of claim 11, wherein the system is further configured to:
retrieve the at least one deduction rule based on at least one enterprise characteristic of the enterprise.

19. The system of claim 18, wherein the at least one enterprise characteristic includes at least one of: a country of formation, an enterprise structure, and a revenue.
